(19) United States
(12) Patent Application Publication
(10) Pub. No.: US 2019/0346874 A1
(43) Pub. Date: Nov. 14, 2019

(54) A HOUSEHOLD APPLIANCE HAVING AN ILLUMINATED ROTARY CONTROL BUTTON

(71) Applicant: ARCELIK ANONIM SIRKETI, Istanbul (TR)

(72) Inventors: Fatih CEYLAN, Istanbul (TR); Ali Ihsan INCUKUR, Istanbul (TR); Yalcin YAMAN, Istanbul (TR)

(21) Appl. No.: 16/307,459

(22) PCT Filed: Jun. 22, 2017
(86) PCT No.: PCT/EP2017/065345

§ 371 Date: Dec. 5, 2018

(30) Foreign Application Priority Data
Jul. 4, 2016 (TR) A 2016/09475

(51) Int. Cl. G05G 1/10

(52) U.S. Cl. CPC G05G 1/105

(57) ABSTRACT

The present invention is a household appliance, in particular a cooker device comprising a rotary control button detachably mounted at a distant-end on a shaft accessible through an opening provided on the front panel, comprising a sleeve having an outwardly facing holding portion on an opposite proximate-end thereof, and an inner ring bearing within at least one LED member positioned so as to illuminate a rotary control button, provided on the outer portion of the front panel so as to surround the sleeve.

### TECHNICAL FIELD

The present invention relates to rotary control buttons of household appliances, in particular mounting details of rotary control buttons having a card comprising a LED circuit for the purpose of illuminating.

### PRIOR ART

In household appliances, for example ovens, a rotary control button having a handle portion is mounted on a shaft reached through a bore located on the front panel on the body. In cooker devices, the rotary control buttons are easily detachable and attachable to the front panel for the purposes of cleaning the dirt which may occur due to reasons such as steam or overflowing of food on the front panel. A sleeve extending in the back portion of the rotary control button is engaged on the shaft to complete mounting of the rotary control button.

Illuminated rotary control buttons are used in household appliances. LED circuits are used in order to provide compact illumination on the rotary control button. A circularly cut LED circuit card adapted to the rotary control button is provided behind the handle portion. A terminal element to supply electricity to the LED circuit of the rotary control button or a switch unit to control thereof according to the performed task is also provided on the rear portion of the rotary control button engaging the body of the household appliance.

Patent publication no. WO2014102384 discloses an illuminated button mountable to the cocks of gas cooker devices or to the commutators of electric cookers. The patent also discloses a switching mechanism enabling electricity transmission to the illuminated button in gas or electric cooker devices having an illuminated button and switch mechanism.

### BRIEF DESCRIPTION OF THE INVENTION

The aim of the present invention is to enable safe attachment-detachment of rotary control buttons to the control panel in household appliances having an illuminated rotary control button.

In order to achieve the above-mentioned aim, the invention is a household appliance, in particular a cooker device comprising a rotary control button detachably mounted at a distant-end on a shaft accessible through an opening provided on the front panel, comprising a sleeve having an outwardly facing holding portion on an opposite proximate-end thereof, and an inner ring bearing within at least one LED member positioned so as to illuminate the rotary control button, provided on the outer portion of the front panel so as to surround the sleeve. In a preferred embodiment of the invention, the central opening provided in the middle of the ring is configured to have a width so that the sleeve is detachable without damage, and is fixed to the front panel independently from the holding portion of the inner ring. In this case, when the sleeve is removed from the shaft by pulling from the holding portion for example for the purpose of cleaning, the ring bearing the LED member maintains its position by staying on the front panel. The units supplying electricity to or switching the LED member maintain their position when the rotary control button is detached.

A preferred embodiment comprises at least one outer ring on one side fixed on the front panel around the opening, and on the other side, at its back portion holding the inner ring to which it is intertwined. The inner ring is fixed to the opening together with the outer ring surrounding it, and also bears the LED member. When the outer ring is mounted on the front panel by a fixing member for example a screw, the inner ring is also positioned before the opening without being damaged during mounting.

A preferred embodiment comprises an illumination assembly on which a plurality of LED members are mounted and having an annular circuit card placed in the inner portion of the inner ring. The LED member can be placed on the annular circuit card circumferentially or otherwise, and the holding member can be circumferentially illuminated with a determined angle from the inner portion selectively or completely.

A preferred embodiment comprises an outer sleeve co-axially surrounding the sleeve in such a manner that the sleeve can engage it through axial motion, and supporting a flange radially extending outwards so as to bias the circuit card to the back edge of the outer ring. The outer sleeve enables mounting of the circuit card to the outer ring without an additional fixing member, for example a screw. The damage-free mounting of the circuit card which is an electronic circuit card enables long-continued operation of the illumination assembly without malfunction.

A preferred embodiment comprises a recess provided in a front extension of the outer sleeve extending to the holding portion, engaging a pim extending from the rotary control button. Thus, when the rotary control button is axially pushed inwards, it holds on to the pim delimiting the axial translational movement.

A preferred embodiment comprises an outer rim extending to the proximity of the opening while surrounding the sleeve so as to encircle the opening. The outer rim prevents undesired items such as dirt or food steam from entering the rotary control button.

A preferred embodiment comprises a diffuser covering the LED member on the side of the inner ring facing the holding portion so as to allow partial light transmission. On the one hand, the diffuser provides light towards the holding portion and on the other hand protects the LED member from external factors.

The household appliance realized to achieve the aims of the present invention is illustrated in the accompanying drawings, wherein:

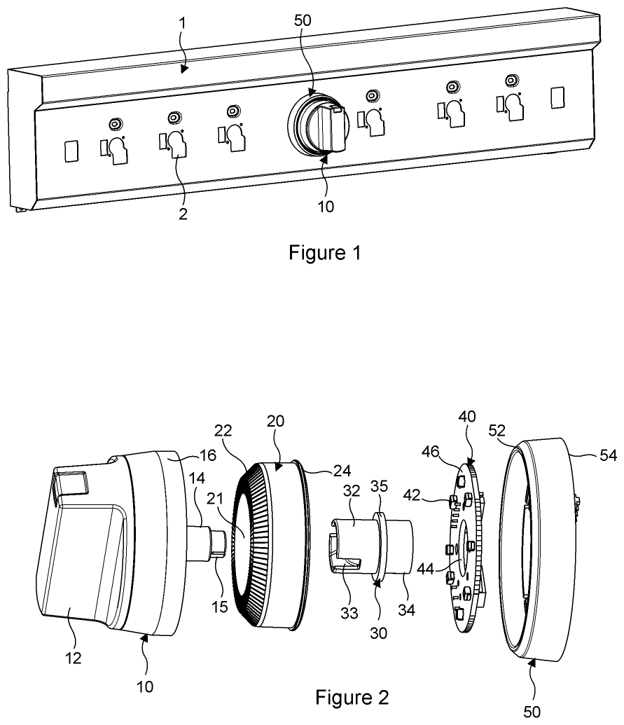

FIG. 1 is a perspective view of a front panel of an oven having a rotary control button.

FIG. 2 is a dismantled view of a representative embodiment of the illuminated rotary control button of the invention.

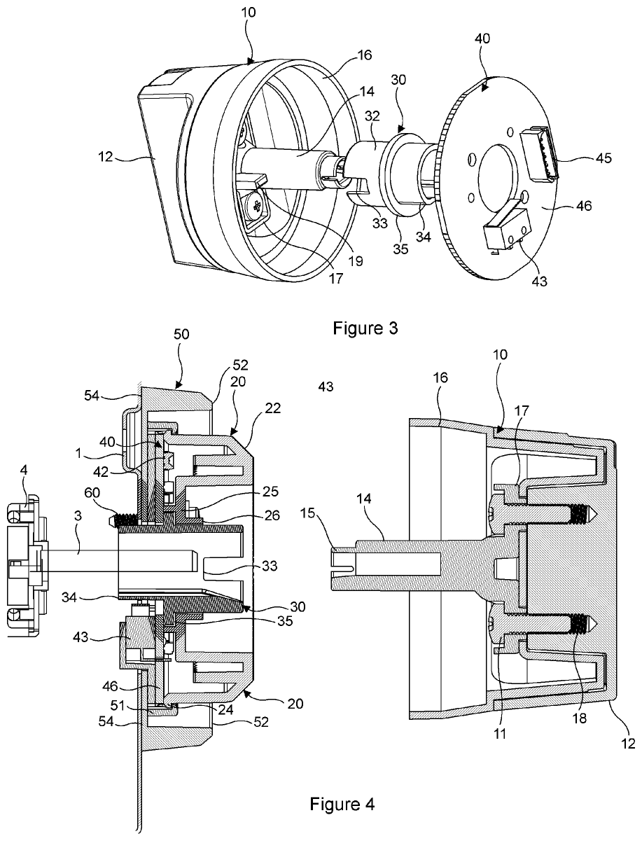

FIG. 3 is a perspective view of the illuminated rotary control button of FIG. 2 in dismantled state from behind.

FIG. 4 is a longitudinal section view of the illuminated rotary control button of FIG. 2 from the center.

The elements in the figures are numbered individually and the correspondence of these numbers are given hereinafter.
1 Front panel
2 Opening
3 Shaft
4 Gas cock
10 Rotary control button
11 Screw
12 Holding portion
14 Sleeve
15 Distant-end
16 Outer rim
17 Mounting seat
18 Screw orifice
19 Pin
20 Inner ring
21 Central opening
22 Diffuser
24 Back flange
25 Thrust protrusion
26 Centering extension
30 Outer sleeve
32 Front extension
33 Recess
34 Back extension
35 Flange
40 Illumination assembly
42 LED member
43 Switch
44 Bore
45 Socket
46 Circuit card
50 Outer ring
51 Holder extension
52 Front edge
54 Back edge
60 Coupling member

FIG. 1 shows a perspective view of a front panel (1) of an oven (not shown). The front panel (1) is a metal sheet panel on which sequential openings (2) are arranged. A shaft (3) coming from a corresponding gas cock (4) can be accessed through the openings (2) A rotary control button (10) is detachably placed to the front panel (1) so as to cover an opening (2). An outer ring (50) fixed to the front panel (1) acts as a seat for the rotary control button (10).

FIG. 2 shows a perspective view of the outer ring (50) and the rotary control button (10) in dismantled state. The rotary control button (10) comprises a holding portion (12) facing outwards shaped to be easily gripped by hand. The holding portion (12) has an outer rim (16) extending vertically with a prismatic structure in initial position, and further extending by conically broadening along the periphery of the annular form which it surrounds. The conical portion of the outer rim (16) hollowly covers to a large extent a hollow cylindrical sleeve (14) extending axially on the center of the rotary control button (10). An inner ring (20) has a hollow ring shape and the sleeve (14) passes from a central opening (21) thereof. A back flange (24) is formed by bending the back end of the inner ring (20) radially outwards. A hollow cylindrical outer sleeve (30) passing from the central opening (21), receives the sleeve (14) inside it through its a front extension (32). A recess (33) of a slot structure is formed at the front end of the outer sleeve (30). A back extension (34) of the outer sleeve (30) is defined by an annular flange (35) radially extending outwards. An illumination assembly (40) of an annular flat structure, in the center of which a bore (44) is provided, is sized suitable to rest inside the outer ring (50) behind it. The illumination assembly (40) comprises an annular circuit card (46) and LED members (42) arranged on a face of the circuit card (42) facing outwards. The outer ring (50) has a lateral wall frustoconical-like extending between a front edge (52) with a diameter matching the outer rim (16), and a back edge (54) with a wider diameter than the front edge (52).

FIG. 3 shows a perspective view of the rotary control button (10) from behind so as to view its inner portion. The sleeve (14) is mounted to the holding portion (12) from the inside by means of a mounting seat (17). The extension axis of the sleeve (14) is on the extension axis of the shaft (3). The outer sleeve (30) is co-axially engaged from the space within to the upper portion of the sleeve (14). Thus, the recess (33) engages the pim (19) extending from the inner face of the holding portion (12). On the other hand, since the flange (35) is wider than the bore (44), the circuit card (46) rests on the flange (35) from its back portion by being moved via the back extension (34) of the outer sleeve (30).

A switch (43) and a socket (45) spaced to the switch (43) are provided on the back face of the circuit card (46). The socket (45) is attached to the power connection (not shown) coming from the opening (2). The LED member (42) is thus supplied electricity.

FIG. 4 shows the longitudinal section of the outer ring (50) in mounted state on the front panel (1), and the rotary control button (10) in detached state. The outer ring (50) is fixed on the front panel (1) by a fixing member (60) shaped as a screw. The fixing member (60) respectively fixes together, the inner ring (20), the outer sleeve (30) via the flange (35) behind the inner ring (20), and the circuit card (46) pushed by the flange (35) to the back wall of the outer ring (50) to the front panel. A short centering extension (26) is arranged on the middle bore of the inner ring (20) extending outwards and surrounding the outer sleeve (30) from its front extension by resting on the flange (35). A circumferential thrust protrusion (25) provided on the back portion of the centering extension (26), supports the circuit card (46) around the bore (44) by extending inwards along the outer circumference of the flange (35).

The shaft (3) coming from the gas cock (4) extends in the space inside the outer sleeve (30). The sleeve (14) extending from the rotary control button (10) is attached by engaging it to the shaft (3) from its distant-end (15). Thus, the gas flow rate of the gas cock (4) is adjusted by the rotary control button (10) resting engaged to the pim (19), rotating the shaft (3) from inside the outer sleeve (30) through which it passes in a circumferentially hollow manner. The LED member (42) illuminates the rotary control button (10) from the back portion by emitting its light through the diffuser (22) having circumferential grooves.

1- A household appliance, in particular a cooker device comprising a rotary control button detachably mounted at a distant-end on a shaft accessible through an opening provided on the front panel, comprising a sleeve having an outwardly facing holding portion on an opposite proximate-end thereof, and an inner ring bearing within at least one light emitting diode (LED) member positioned so as to illuminate a rotary control button, provided on the outer portion of the front panel so as to surround the sleeve, characterized in that, a central opening provided in the middle of the inner ring is configured to have a width so that the sleeve is detachable without damage, and in that the inner ring is fixed to the front panel independently from the holding portion.

2- The household appliance according to claim 1, comprising at least one outer ring on one side fixed on the front panel around the opening, and on the other side, at its back portion holding the inner ring to which it is intertwined.

3- The household appliance according to claim 2, comprising an illumination assembly on which a plurality of LED members are mounted and having an annular circuit card placed in the inner portion of the inner ring.

4- The household appliance according to claim 3, comprising an outer sleeve co-axially surrounding the sleeve in such a manner that the sleeve can engage it through axial motion, and supporting a flange radially extending outwards so as to bias the circuit card to the back edge of the outer ring.

5- The household appliance according to claim 4, comprising a recess provided on a front extension of the outer sleeve extending to the holding portion, and engaging a pin extending from the rotary control button.

6- The household appliance according to claim 1, wherein the holding portion comprises an outer rim extending to proximity of the opening and encircling the sleeve in such a manner to surround the opening.

7- The household appliance according to claim 1, comprising a diffuser covering the LED member on the side of the inner ring facing the holding portion so as to allow partial light transmission.
